(19) United States
(12) Patent Application Publication
(10) Pub. No.: US 2004/0114401 A1
(43) Pub. Date: Jun. 17, 2004

(54) Switched-mode power supply

(75) Inventors: Paolo De Anna, Riese Pio X (IT); Ugo Francescutti, Ponzano Veneto (IT)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, Munchen (DE)

(21) Appl. No.: 10/730,931

(22) Filed: Dec. 10, 2003

(30) Foreign Application Priority Data
Dec. 11, 2002 (DE) 102 57 908.3

(51) Int. Cl. H02H 7/122

(52) U.S. Cl. 363/56.12

(57) ABSTRACT

Switched-mode power supply having a series circuit of an electronic switch (T1) and the primary winding (W1) of a transformer (TX1). The power supply also has a switching snubber device in which, when the electronic switch (T1) is switched off, the energy in the primary winding (W1) is stored in a capacitor (C1). According to the invention, the switching snubber device has a further electronic switch (D1, T2) which remains switched on until the energy stored in the capacitor (C1) is fed back again into the transformer (TX1).

### FIELD OF THE INVENTION

The invention relates to a switched-mode power supply according to the preamble of claim 1. Switched-mode power supplies are referred to below as power supply for short. The invention essentially relates to a power supply with a switching snubber device. The power supply is suitable for operating light sources.

### BACKGROUND OF THE INVENTION

Power supplies, such as are known, for example, from Mohan, Undeland, Robins: “Power Electronics”, John Wiley & Sons, 1995, New York, USA, Chapters 7 and 10 have at least one electronic switch. When these switches are operated, switching losses occur which can be reduced by switching snubber devices. An overview of such switching snubber devices is given, for example, in the following text: Philip C. Todd: “Snubber Circuits: Theory, Design and Application” in the Power Supply Design Seminar Manual, UNITRODE, Merrimack, N.H., USA, 1993. There, the differences between dissipative and non-dissipative switching snubber devices are described.

Dissipative switching snubber devices can be realized with little outlay. However, they do have the disadvantage that they may result in high losses and high parasitic oscillations. The losses reduce the efficiency of the switched-mode power supply, and the parasitic oscillations cause radio interference.

A non-dissipative snubber circuit for a DC chopper controller is described in the publication EP 0 798 857 (Osterried). This circuit contains at least 2 diodes and an inductor. In particular, the inductor entails considerable outlay for realizing the snubber circuit.

### SUMMARY OF THE INVENTION

The object of the present invention is to provide a power supply which has a switching snubber device which can be realized with little outlay, produces a low power loss and excites few parasitic oscillations. This object is achieved by a power supply having the following features:

A first and a second energy feed point,

a transformer having a primary and a secondary winding, it being possible for the secondary winding to be connected to a load,

a first electronic switch which is connected in series with the primary winding,

the series circuit of the first electronic switch and the primary winding is coupled to the first and the second energy feed point,

a switching snubber device which is connected in parallel with the primary winding or in parallel with the first electronic switch and which contains the series circuit of a capacitor and a second electronic switch,

the series circuit of the capacitor and the second electronic switch causes the energy, which is represented by the current in the primary winding when the first electronic switch is switched off, to be at least partially absorbed by the capacitor,

the second electronic switch causes a substantial part of the energy absorbed by the capacitor to be fed back into the transformer.

The invention is based on a power supply having a transformer which has a primary and a secondary winding. The secondary winding can be connected to a load. The transformer may have two or more secondary windings, it being possible for each secondary winding to be connected to in each case one load.

In general, each electrical consumer may represent a load. However, the invention is suitable, in particular, for transforming a mains voltage of, for example, 230 Veff into a DC or AC voltage of less than 50 V. It is thus possible to operate electronic appliances, for example.

Owing to the stringent requirements in terms of power loss and radio interference in lighting engineering, the invention is particularly suitable for operating light sources. Incandescent lamps, light-emitting diodes or so-called OLEDs (Organic Light Emission Devices) may be used in this case, for example. When operating light-emitting diodes it is advantageous to rectify and smooth the AC voltage provided across the secondary winding.

In addition, the invention is based on the assumption that the power supply has a first and a second energy feed point. These energy feed points are provided for feeding a DC supply voltage. The DC supply voltage may be provided, for example, by a battery or by rectification and smoothing of a mains voltage.

In addition, the invention is based on the assumption that a first electronic switch is connected in series with the primary winding. The resultant series circuit is coupled to the first and the second energy feed point. If the first electronic switch is closed, the DC supply voltage causes the current in the primary winding to increase. This principle is realized in many topologies for switched-mode power supplies. These are described in the abovementioned text (Mohan, Undeland, Robins: “Power Electronics”, John Wiley & Sons, 1995, New York, USA, Chapters 7 and 10). The so-called flyback converter is in common use, since this topology can be realized in a cost-effective manner at low power (up to 100 W).

After a predetermined time, the first electronic switch is switched off again. This switching-off operation prevents the current built up in the primary winding from continuing to flow through the first electronic switch. If no switching snubber device is provided, a high voltage builds up across the working terminals of the first electronic switch and results in high losses in the first electronic switch and may lead to the switch being destroyed.

In addition, the invention is based on the assumption that the power supply contains a switching snubber device. The switching snubber device contains at least the series circuit of a capacitor and a second electronic switch.

In addition, the invention is based on the assumption that the switching snubber device is connected into the power supply such that the energy, which is represented by the current in the primary winding when the first electronic switch is switched off, is at least partially absorbed by the capacitor.

Since, in the prior art, the second electronic switch is in the form of a fast diode, the energy absorbed by the capacitor can no longer flow away via the second electronic switch. Care must therefore be taken in the prior art to ensure that the capacitor is discharged before the switch is switched off again. This takes place in the prior art by means of a first resistor which provides a discharge current path for the capacitor. The energy stored in the capacitor is converted in the first resistor into lost power. If a high value is selected for the first resistor, oscillations in the voltage present across the working terminals of the first electronic switch result. These oscillations may cause radio interference.

As described above, a fast diode is used for the second electronic switch in the prior art. The response time of a diode is generally described by a reverse recovery time. If, after a period of time for which a current is flowing through the diode in the forward direction, the direction of the current is reversed, during the reverse recovery time a current flows in the reverse direction through the diode. The reverse recovery time in diodes according to the prior art is so short that the capacitor may be discharged to only an insignificant extent during the reverse recovery time.

According to the invention, the second electronic switch causes a substantial part of the energy absorbed by the capacitor to be fed back into the transformer.

Once the energy, which is represented by the current in the primary winding of the transformer when the first electronic switch is switched off, has been dissipated, the current in the primary winding, which previously flowed in a positive direction, is reduced to zero. A diode according to the prior art prevents the current in the negative direction from being increased. A second electronic switch according to the invention allows a current to flow in the negative direction. This is the case until the energy stored in the capacitor in the form of a current in the primary winding has been fed back into the transformer. A large proportion of the energy fed back is output by the transformer via its secondary winding to the load. Advantageously, only a little power loss is thus produced in the power supply.

Also of advantage is the fact that the resonant circuit, formed by the primary winding and the capacitor, is damped by the load. This suppresses parasitic oscillations.

### BRIEF DESCRIPTION OF THE DRAWINGS

The invention will be explained in more detail below using exemplary embodiments and with reference to drawings, in which:

FIG. 1 shows an exemplary embodiment according to the invention of a power supply,

FIG. 2 shows the time profile of the voltage across the working terminals of the first electronic switch according to the prior art,

FIG. 3 shows the time profile according to the invention of the voltage across the working terminals of the first electronic switch,

FIG. 4 shows a further exemplary embodiment according to the invention of a power supply, and

FIG. 5 shows a further exemplary embodiment according to the invention of a power supply.

In the text below, resistors are denoted by the letter R, transistors by the letter T, diodes by the letter D, capacitors by the letter C, in each case followed by a numeral. In addition, in the text which follows, the same elements, and elements having the same function, of the different exemplary embodiments are provided with the same reference symbols throughout.

### PREFERRED EMBODIMENT OF THE INVENTION

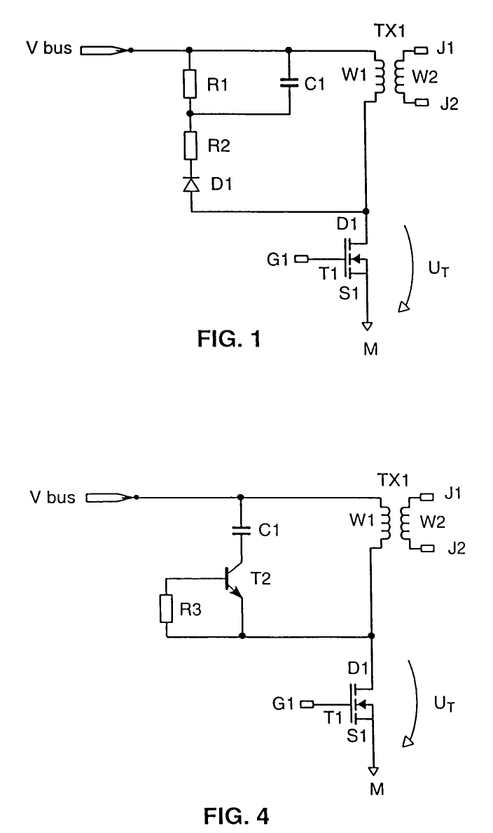

FIG. 1 shows an exemplary embodiment according to the invention of a power supply. A DC supply voltage can be connected to a terminal Vbus with respect to a reference potential M. The series circuit of the primary winding W1 of a transformer TX1 and a first electronic switch, which is in the form of an N-channel MOSFET T1, is connected between the terminal Vbus and the reference potential M. Other electronic switches may also be used, such as, for example, IGBTs, bipolar transistors or P-channel MOSFETs. The drain terminal D1 of T1 forms a working terminal of T1 and is connected to the primary winding W1. The source terminal S1 of T1 is connected to the reference potential M. The gate terminal G1 of T1 is connected to a control circuit (not shown). The control circuit ensures that T1 is switched on and off according to the requirements for the power supply.

The series circuit of T1 and the primary winding W1 is selected such that T1 is connected to the reference potential M. This has the advantage that the control circuit needs to provide a signal which is also based on the reference potential M. The outlay for the control circuit may thus be kept low. It is, however, also possible to exchange the primary winding W1 and T1 in the series circuit such that the primary winding W1 is connected to the reference potential M.

The secondary winding W2 of the transformer TX1 has two terminals J1 and J2 to which a load can be connected.

Connected in parallel with the primary winding W1 is the series circuit of a first resistor R1, a second resistor R2 and a second electronic switch. The second electronic switch is in the form of a diode D1 which is polarized such that it blocks the flow of current from the terminal Vbus to the reference potential M.

A capacitor C1 is connected in parallel with the first resistor R1.

A voltage between the working terminals of the transistor UT is marked between the drain terminal D1 and the source terminal S1.

If T1 is closed, the DC supply voltage results in a positive current through the primary winding W1. If T1 is switched off, this current continues to flow through D1 and charges the capacitor C1 until the current is reduced to a value of zero. The second resistor R2 limits the current through D1. This may be important for a cost-effective selection of components. The value of the second resistor may, however, also be zero. Since R2 also damps the resonant circuit represented by the primary winding W1 and C1, a given limit for parasitic oscillations may be exceeded when R2 has the value zero. In this case, the value for R2 needs to be increased until the given limit for parasitic oscillations is maintained.

According to the invention, D1 now has a reverse recovery time which allows a negative current flow through the primary winding. The reverse recovery time is long enough to completely discharge C1. The majority of the energy stored in C1 is thus output via the transformer to the load. Only an insignificant fraction is dissipated in the first resistor R1. R1 serves besides the purpose of further damping parasitic oscillations which, despite a design of D1 according to the invention, still occur to a slight extent. The first resistor R1 may, however, also be dispensed with.

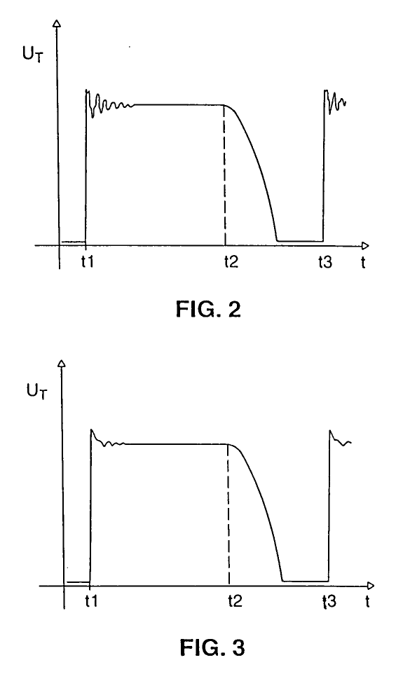

FIG. 2 shows the profile of the voltage UT from FIG. 1 plotted against time t, but for a design of D1 which corresponds to the prior art. At time t1, T1 switches off and the voltage UT increases rapidly. The value of the voltage UT is, admittedly, limited by the switching snubber device, but a parasitic oscillation, triggered by the switching-off process, can clearly be seen. Once the parasitic oscillation has decayed, the voltage UT is adjusted to a value which corresponds to the sum of the DC supply voltage and the output voltage, transformed into the primary winding W1, across the secondary winding W2. During operation on a mains voltage, this value may be, for example, between 100 V and 350 V. The frequency of the parasitic oscillation is typically in the MHz range.

At time t2, T1 switches on again and the voltage UT is reduced again to negligible values. With power supplies which are suitable for operating light-emitting diodes on a mains voltage, there is a time interval of 5 microseconds, for example, between times t1 and t2. At time t3, T1 switches off again and the described process is repeated cyclically. The cycle time in the abovementioned application is 8 microseconds, for example.

FIG. 3 shows the profile of the voltage UT from FIG. 1 plotted against time t, as is produced when the reverse recovery time of D1 is designed according to the invention. The amplitude of the interference voltage is markedly reduced. Less outlay is thus required for radio interference. A further advantage, which cannot be seen in FIG. 3, is the reduced loss of power which is dissipated in the first resistor R1.

A lower limit value for the reverse recovery time of D1 can be seen in FIG. 2. The reverse recovery time of D1 needs to be at least as long as the cycle time of the parasitic oscillation which would result according to the prior art. With parasitic oscillations in the MHz range, a minimal reverse recovery time of D1 of one microsecond results.

FIG. 4 shows a further exemplary embodiment according to the invention of a power supply. In comparison with FIG. 1, the second electronic switch in FIG. 4 is in the form of a bipolar transistor T2. The switching snubber device, which is connected in parallel with the primary winding W1, comprises the capacitor C1, the transistor T2 and the resistor R3. The series circuit of C1 and the collector/emitter path of T2 is connected in parallel with the primary winding W1. R3 is connected in parallel with the base/emitter path of T2.

In comparison with FIG. 1, the resistor R1 is not included in FIG. 4. The function of the diode D1 is taken on by the base/collector path of T2. The positive current of the primary winding W1 is conducted via the resistor R3 and the base/collector path of T2 once T1 has been switched off, and thus charges C1. When a transistor T2 is used, the reverse recovery time of the diode D1 is represented by its storage time. A transistor therefore needs to be selected for T2 whose storage time corresponds to the reverse recovery time of a diode designed according to the invention. A negative current in the primary winding W1 may flow during the storage time of T2. If, instead of a diode for the second electronic switch, a transistor is used, the power loss in the second electronic switch is advantageously reduced. Also of advantage is the fact that the storage time of T2 can be set by the resistor R3. It is thus possible to adjust the time for which a negative current flows through the primary winding W1.

It is also possible to use a MOSFET or another electronic switch instead of the bipolar transistor for T2. It may be necessary to provide for this switch a drive circuit which opens and closes the switch at the required times. The switch needs to be closed when the first electronic switch is open, and to be opened when the capacitor C1 is discharged again following the charging process. The second electronic switch needs, however, to be opened at the latest when the first electronic switch is closed again.

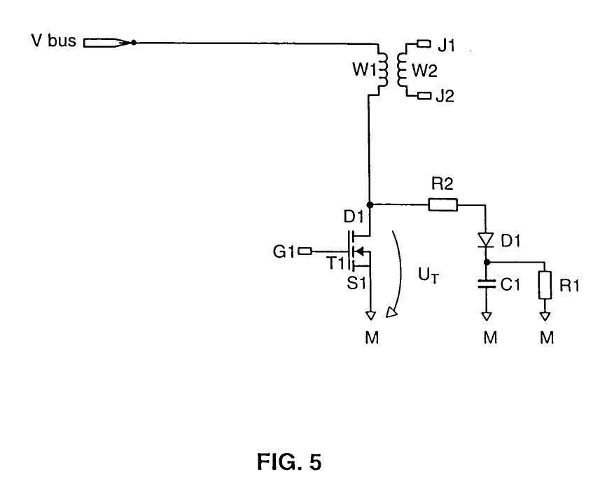

FIG. 5 shows a further exemplary embodiment according to the invention of a power supply. In comparison with FIGS. 1 and 4, the switching snubber device in FIG. 5 is not connected in parallel with the primary winding W1, but is connected in parallel with the first electronic switch T1. In FIG. 5, the switching snubber device comprises the series circuit of a resistor R2, a diode D1 and a capacitor C1. A resistor R1 is connected in parallel with C1. The operation of these components corresponds to the operation of the components in the other figures having the same reference symbols. As in FIG. 4, the diode D1 in FIG. 5 may also be replaced by a transistor.

When considering AC operation, coupling the switching snubber device to the terminal Vbus has the same effect as coupling it to the reference potential M. This results in the DC supply voltage, which is connected between the terminals Vbus and M, since it acts as a short-circuit for alternating currents. The voltage rise across the working terminals of T1 during the switching-off process can be flattened in the exemplary embodiment in FIG. 5. The layout may also be of more simple design for one or the other exemplary embodiment.

1. A power supply having the following features:
a first and a second energy feed point (Vbus, M),
a transformer (TX1) having a primary (W1) and a secondary winding (W2), it being possible for the secondary winding to be connected to a load,
a first electronic switch (T1) which is connected in series with the primary winding (W1),
the series circuit of the first electronic switch (T1) and the primary winding (W1) is coupled to the first and the second energy feed point (Vbus, M),
a switching snubber device which is connected in parallel with the primary winding (W1) or in parallel with the first electronic switch (T1) and which contains the series circuit of a capacitor (C1) and a second electronic switch (D1, T2),
the series circuit of the capacitor (C1) and the second electronic switch (D1, T2) causes the energy, which is represented by the current in the primary winding (W1) when the first electronic switch (T1) is switched off, to be at least partially absorbed by the capacitor (C1),
the second electronic switch (D1, T2) causes a substantial part of the energy absorbed by the capacitor (C1) to be fed back into the transformer (TX1).

2. The power supply as claimed in claim 1, wherein a first resistor (R1) is connected in parallel with the capacitor (C1).

3. The power supply as claimed in claim 1 or 2, wherein a second resistor (R2) is connected in series with the second electronic switch (D1, T2).

4. The power supply as claimed in claim 1, characterized in that a diode (D1) forms the second electronic switch, the diode (D1) having a reverse recovery time which is longer than the time which elapses before a substantial part of the energy absorbed by the capacitor (C1) is fed back into the transformer (TX1).

5. The power supply as claimed in claim 4, wherein the diode (D1) has a reverse recovery time of at least one microsecond.

6. The power supply as claimed in claim 1, wherein a bipolar transistor (T2) forms the second electronic switch, the bipolar transistor (T2) having a storage time which is longer than the time which elapses before a substantial part of the energy absorbed by the capacitor (C1) is fed back into the transformer (TX1).

7. The power supply as claimed in claim 6, wherein the bipolar transistor (T2) has a storage time of at least one microsecond.

8. The power supply as claimed in claim 6 or 7, wherein a third resistor (R3) is connected in parallel with a base/emitter path of the bipolar transistor (T2).

9. The power supply as claimed in claim 1, wherein light sources form the load.

10. The power supply as claimed in claim 1, wherein light-emitting diodes form the load.
